(19) United States
(12) Patent Application Publication
(10) Pub. No.: US 2013/0230105 A1
(43) Pub. Date: Sep. 5, 2013

(54) INTRA-PREDICTION ENCODING/DECODING APPARATUS AND METHOD FOR OMITTING THE TRANSMISSION OF PREDICTION MODE INFORMATION USING CHARACTERISTICS OF REFERENCE PIXELS

(71) Applicants: Jinhan Song, Seoul (KR); Jeongyeon Lim, Gyeonggi-do (KR); Tae Young Jung, Seoul (KR); Hyuk Lee, Seoul (KR); Jechang Jeong, Seoul (KR)

(72) Inventors: Jinhan Song, Seoul (KR); Jeongyeon Lim, Gyeonggi-do (KR); Tae Young Jung, Seoul (KR); Hyuk Lee, Seoul (KR); Jechang Jeong, Seoul (KR)

(73) Assignee: SK TELECOM CO., LTD., Seoul (KR)

(21) Appl. No.: 13/821,528

(22) PCT Filed: Sep. 7, 2011
(86) PCT No.: PCT/KR2011/006625

§ 371 Date: May 21, 2013

(30) Foreign Application Priority Data
Sep. 7, 2010 (KR) 10-2010-0087292

(51) Int. Cl. H04N 7/26

(52) U.S. Cl. CPC H04N 19/00569
USPC 375/240.12

(57) ABSTRACT

An intra-prediction encoding/decoding apparatus and method is provided that omits transmission of prediction mode information using characteristics of reference pixels. The present disclosure provides an intra-prediction encoding apparatus and method for omitting transmission of additional information of a predicted mode of the current block through the use of characteristics of reference pixels adjacent to a current block and thereby reducing overhead when a bitstream is generated, and improving the efficiency of encoding and decoding an image while maintaining the accuracy of intra-predictions.

The intra-prediction encoding apparatus includes a characteristic information calculator for calculating characteristic information of a directionality by selecting at least one reference pixels adjacent to a current block to encode, a comparer for comparing between a predetermined reference value and the characteristic information of the directionality calculated by the characteristic information calculator, a prediction mode determining unit for determining a prediction mode for the current block to be a mode corresponding to the selected reference pixel when a result of the comparison performed by the comparer satisfies a predetermined condition, and an encoder for encoding a residual between a predicted block according to the determined mode and the current block, and omitting encoding mode information of the determined mode when the result of the comparison satisfies the predetermined condition.

### TECHNICAL FIELD

The present disclosure relates in some embodiments to an intra-prediction encoding/decoding apparatus and method. More particularly, the present disclosure relates in some embodiments to an intra-prediction encoding/decoding apparatus and method that omit transmission of additional information on a prediction mode of a current block by using characteristics of reference pixels neighboring the current block and thus, can reduce overhead occurring when a bitstream is generated, and can improve efficiency of image encoding and decoding while maintaining accuracy of the intra-prediction.

### BACKGROUND

The statements in this section merely provide background information related to the present disclosure and may not constitute prior art.

Along with the development of information and communication technology including the Internet, video communications have been increased in addition to text and voice communications. A voice or text-centered communications are insufficient to satisfy various consumers' needs. Therefore, multimedia services that include various types of information such as text, image, music, and the like are on the rise. The amount of multimedia data is huge and thus, the multimedia data requires a large-capacity storage medium as well as a wide bandwidth for transmission. Therefore, to transmit multimedia data including text, image, and audio data, a compression encoding scheme may be required.

A basic principle of compressing data is a process of removing redundancies in data. Data can be compressed by the removal of a spatial redundancy such as when the same colors or objects are repeated in an image, a temporal redundancy as when few changes occur among neighboring frames in a video frame or as when the same sound is repeated in an audio signal, or psychovisual redundancy that reflects human sight and perception being insensitive to a high frequency.

Among video compression methods, interests are focused on H.264/AVC (Advanced Video Coding) having further improved compression efficiency over MPEG-4 (Moving Picture Experts Group-4).

H.264 is a digital video codec standard having a significantly high data compression rate, which is also referred to as MPEG-4 part 10 or AVC (advanced video coding). It is the result of standardization by Joint Video Team of VCEG (video coding experts group of ITU-T (International Telecommunication Union Telecommunication Standardization Sector) and MPEG of ISO/IEC (International Standardization Organization/International Electrotechnical Commission).

Various methods have been proposed to improve the compression efficiency in compression encoding, and a temporal prediction method and a spatial prediction method are the most popular ones.

The temporal prediction, as illustrated in FIG. 1, predicts a current block 112 of a current frame 110 by referring to a reference block 122 of a different frame 120 that is temporally adjacent to the current frame 110. When the current block 112 of the current frame 110 is inter-predicted, the temporally adjacent reference frame 120 is detected, and the reference block 122 which is the most similar to the current block 112 is detected from the reference frame 120. Here, the reference block 122 is a block that best predicts the current block 112, and a block that has the smallest SAD (sum of absolute difference) from the current block 112 may be determined as the reference block 122. The reference block 122 may be determined as a predicted block of the current block 112, and a residual block is generated by subtracting the reference block 122 from the current block 112. The generated residual block is encoded and inserted into a bitstream. In this example, the relative difference between the position of the current block 112 in the current frame 110 and the position of the reference block 122 in the reference frame 120 is referred to as a motion vector 130 which may also be encoded in the same manner as the residual block. The temporal prediction is referred to as inter-prediction.

The spatial prediction obtains predicted pixel values of a target block using a reconstructed pixel value of a reference block adjacent to the target block in a single frame, which is referred to as directional intra-prediction (hereinafter simply referred to as intra-prediction). H.264 defines an encoding/decoding scheme using the intra-prediction.

The intra-prediction predicts values of a current sub-block by making decidedly oriented copies of neighboring pixels in an upper direction or left direction of the single sub-block, and encodes only their differentials. According to the intra-prediction by the H.264 standard, a predicted block of the current block is generated based on another block having an earlier coding order. A value obtained by subtracting the predicted block from the current block is coded. A video encoder according to H.264 selects a prediction mode that minimizes the difference between the current block and the predicted block from among prediction modes, for each block.

The intra-prediction according to the H.264 standard defines nine prediction modes as illustrated in FIG. 2, based on directionality of prediction and positions of adjacent pixels used for generating predicted pixel values of a 4×4 luma block and an 8×8 luma block. The nine prediction modes are defined, based on the directionality of prediction, as a vertical prediction mode (prediction mode 0), a horizontal prediction mode (prediction mode 1), a DC prediction mode (prediction mode 2), a diagonal_down_left prediction mode (prediction mode 3), a diagonal_down_right prediction mode (prediction mode 4), a vertical_right prediction mode (prediction mode 5), a horizontal_down prediction mode (prediction mode 6), a vertical_left prediction mode (prediction mode 7), and a horizontal_up prediction mode (prediction mode 8). Here, the DC prediction mode uses the average value of the eight adjacent pixels.

For the intra-prediction processing with respect to a 16×16 luma block, four prediction modes are used, including a vertical prediction mode (prediction mode 0), a horizontal prediction mode (prediction mode 1), a DC prediction mode (prediction mode 2), and a plane prediction mode (prediction mode 3). In addition, for intra-prediction processing with respect to an 8×8 chroma block, the same four prediction modes are used.

FIG. 3 illustrates an example of labeling for illustrating the nine prediction modes of FIG. 2. In this example, a predicted block (an area including pixels a through p) of a current block may be generated by using samples (pixels A through M) decoded in advance. In a case where E, F, G, and H are not decoded in advance, E, F, G, and H may be virtually generated by copying D into their positions.

FIG. 4 illustrates the 9 prediction modes of FIG. 2 with reference to FIG. 3. Referring to FIG. 4, in case of prediction mode 0, a predicted block predicts the same pixel value for each vertical line. Specifically, the predicted block has pixels of values predicted from pixels disposed in an upper reference block and immediately adjacent to the predicted block. A reconstructed pixel value of an adjacent pixel A may be set to be a predicted pixel value of pixel a, pixel e, pixel i, and pixel m in the first column of the predicted block. In the same manner, pixel values of pixel b, pixel f, pixel j, and pixel n in the second column may be predicted from a reconstructed pixel value of an adjacent pixel B. Pixel values of pixel c, pixel g, pixel k, and pixel o in the third column may be predicted from a reconstructed pixel value of an adjacent pixel C. Pixel values of pixel d, pixel h, pixel l, and pixel p in the fourth column may be predicted from a reconstructed pixel value of an adjacent pixel D. Accordingly, a predicted block including columns respectively having pixel values of pixel A, pixel B, pixel C, and pixel D may be generated.

Additionally, in case of prediction mode 1, a predicted block predicts pixels into the same pixel value for each horizontal line. That is, in pixels of the predicted block, pixel values may be predicted from pixels most adjacent to a reference block located to the left of the predicted block. A reconstructed pixel value of an adjacent pixel l may be set to a predicted pixel value with respect to pixel a, pixel b, pixel c and pixel d in a first row of the predicted block. In the same manner, pixel values of pixel e, pixel f, pixel g and pixel h in a second row may be predicted from a reconstructed pixel value of an adjacent pixel J. Pixel values of pixel i, pixel j, pixel k, and pixel l in a third row may be predicted from a reconstructed pixel value of an adjacent pixel K. Pixel values of pixel m, pixel n, pixel o and pixel p in a fourth row may be predicted from a reconstructed pixel value of an adjacent pixel L. Accordingly, a predicted block including rows respectively having pixel values of pixel I, pixel J, pixel K and pixel L may be generated.

Additionally, in case of prediction mode 2, pixels of a predicted block may be equally replaced with an average of the upper pixels A, B, C and D and the left pixels I, J, K and L.

In case of prediction mode 3, pixels of a predicted block may be interpolated in a lower-left direction at an angle of 45 degrees between the lower-left direction and an upper-right direction. In case of prediction mode 4, pixels of a predicted block may be extrapolated in a lower-right direction at an angle of 45 degrees. Also, in case of prediction mode 5, pixels of a predicted block may be extrapolated in a lower-right direction at an angle of about 26.6 degrees (width/height=1/2) with respect to a vertical line. In addition, in case of prediction mode 6, pixels of a predicted block may be extrapolated in a lower-right direction at an angle of about 26.6 degrees with respect to a horizontal line. In case of prediction mode 7, pixels of a predicted block may be extrapolated in a lower-left direction at an angle of about 26.6 degrees with respect to a vertical line. In case of prediction mode 8, pixels of a predicted block may be interpolated in an upper direction at an angle of about 26.6 degrees with respect to a horizontal line.

In the prediction mode 3 through the prediction mode 8, pixels of a predicted block may be generated from a weighted average of pixels A through M of the reference block decoded in advance. For example, in the case of the prediction mode 4, pixel d located on an upper-right side of the predicted block may be estimated as shown in Equation 1. Here, function round ( ) may be a function of rounding off to the nearest whole number.

d=round (B/4+C/2+D/4) Equation 1

As described in the foregoing, a 16×16 prediction model for a luma component may include four modes including prediction mode 0, prediction mode 1, prediction mode 2 and prediction mode 3.

In case of prediction mode 0, pixels of a predicted block may be extrapolated from upper pixels. In case of prediction mode 1, pixels of a predicted block may be extrapolated from left pixels. Further, in case of prediction mode 2, pixels of a predicted block may be calculated to be an average of upper pixels and left pixels. Lastly, in case of prediction mode 3, a linear “plane” function which is suitable for upper pixels and left pixels may be used. Prediction mode 3 is more suitable for an area in which the luminance is smoothly changed.

In the H.264 standard, each prediction mode excluding the DC mode generates pixel values of a predicted block according to a corresponding direction of a corresponding mode based on neighboring pixels of the predicted block to be currently encoded. Prediction mode information of a current block predicted as above by the encoder may be additionally transmitted to the decoder through a bitstream so that decoders may reconstruct the current block using the same prediction mode.

However, the encoder has different varieties of additional information than such prediction mode information to transmit via the bitstream to the decoders, in which the more the amount of additional information transmission via the bitstream becomes, the lower the efficiency of encoding and decoding becomes due to the overhead of the bitstream.

### DISCLOSURE

### Summary

An embodiment of the present disclosure provides an intra-prediction encoding/decoding apparatus including an encoder for calculating a variance value by selecting at least one of reference pixels adjacent to a current block to encode for determining a prediction mode of the current block to be a mode corresponding to the selected reference pixel from a comparison between the calculated variance value and a predetermined reference value, and encoding the current block based on the determined prediction mode, and a decoder for calculating a variance value by selecting at least one of second reference pixels adjacent to the current block to decode, for determining a second prediction mode of the current block to decode to be a mode corresponding to the selected second reference pixel from a comparison between the calculated variance for the selected second reference pixel and the predetermined reference value, and for decoding the current block based on the determined second prediction mode.

Another embodiment of the present disclosure provides an intra-prediction encoding apparatus, the apparatus including a characteristic information calculator for calculating characteristic information of a directionality by selecting at least one of reference pixels adjacent to a current block to encode, a comparer for comparing between a predetermined reference value and the characteristic information of the directionality calculated by the characteristic information calculator, a prediction mode determining unit for determining a prediction mode for the current block to be a mode corresponding to the selected reference pixel when a result of the comparison performed by the comparer satisfies a predetermined condition, and an encoder for encoding a residual between a predicted block according to the determined mode and the current block and omitting encoding mode information of the determined mode when the result of the comparison satisfies the predetermined condition.

The characteristic information calculator includes an upper side variance value calculator for calculating a variance value with respect to reference pixels located on an upper side of the current block, and a left side variance value calculator for calculating a variance value with respect to reference pixels located on a left side of the current block.

The prediction mode determining unit determines a DC mode to be the prediction mode of the current block when the variance value calculated by the upper side variance value calculator and the variance value calculated by the left side variance value calculator are less than the reference value.

The prediction mode determining unit determines a horizontal mode to be the prediction mode of the current block when the variance value calculated by the upper side variance value calculator is less than the reference value and the variance value calculated by the left side variance value calculator is greater than or equal to the reference value.

The prediction mode determining unit determines a vertical mode to be the prediction mode of the current block when the variance value calculated by the upper side variance value calculator is greater than or equal to the reference value and the variance value calculated by the left side variance value calculator is less than the reference value.

Another embodiment of the present disclosure provides an intra-prediction decoding apparatus, the apparatus including a characteristic information calculator for calculating characteristic information of a directionality by selecting at least one of reference pixels adjacent to a current block to decode, a comparer to compare for comparing between a predetermined reference value and the characteristic information of the directionality calculated by the characteristic information calculator, a prediction mode determining unit for determining a prediction mode for the current block to be a mode corresponding to the selected reference pixel when a result of comparison performed by the comparer satisfies a predetermined condition, and a decoder for decoding the current block based on the mode determined by the prediction mode determining unit when the result of the comparison satisfies the predetermined condition.

The characteristic information calculator includes an upper side variance value calculator for calculating a variance value with respect to reference pixels located on an upper side of the current block, and a left side variance value calculator for calculating a variance value with respect to reference pixels located on a left side of the current block.

The prediction mode determining unit determines a DC mode to be the prediction mode of the current block when the variance value calculated by the upper side variance value calculator and the variance value calculated by the left side variance value calculator are less than the reference value.

The prediction mode determining unit determines a horizontal mode to be the prediction mode of the current block when the variance value calculated by the upper side variance value calculator is less than the reference value and the variance value calculated by the left side variance value calculator is greater than or equal to the reference value.

The prediction mode determining unit determines a vertical mode to be the prediction mode of the current block when the variance value calculated by the upper side variance value calculator is greater than or equal to the reference value and the variance value calculated by the left side variance value calculator is less than the reference value.

Another embodiment of the present disclosure provides an intra-prediction encoding/decoding method including performing an encoding for calculating a variance value by selecting at least one of reference pixels adjacent to a current block to encode for determining a prediction mode of the current block to be a mode corresponding to the selected reference pixel from a comparison between the calculated variance value and a predetermined reference value, and encoding the current block based on the determined prediction mode, and performing a decoding for calculating a variance value by selecting at least one of second reference pixels adjacent to the current block to decode for determining a second prediction mode of the current block to be a mode corresponding to the selected second reference pixel from a comparison between the calculated variance for the selected second reference pixels and the predetermined reference value, and decoding the current block based on the determined second prediction mode.

Another embodiment of the present disclosure provides an intra-prediction encoding method including performing a characteristic information calculation for calculating characteristic information of a directionality by selecting at least one of reference pixels adjacent to a current block to encode, performing a comparison for comparing between a predetermined reference value and the characteristic information of the directionality calculated by the characteristic information calculator, performing a prediction mode determination for determining a prediction mode for the current block to be a mode corresponding to the selected reference pixel when a result of the comparison satisfies a predetermined condition, and encoding a residual between a predicted block according to the determined mode and the current block and omitting encoding mode information of the determined mode when the result of the comparison satisfies the predetermined condition.

The characteristic information calculation includes performing an upper side variance calculation to calculate a variance value with respect to reference pixels located on an upper side of the current block, and performing a left side variance calculation to calculate a variance value with respect to reference pixels located on a left side of the current block.

The prediction mode determination includes determining a DC mode to be the prediction mode of the current block when the variance value calculated in the upper side variance value calculation and the variance value calculated in the left side variance value calculation are less than the reference value.

The prediction mode determination includes determining a horizontal mode to be the prediction mode of the current block when the variance value calculated in the upper side variance value calculation is less than the reference value and the variance value calculated in the left side variance value calculation is greater than or equal to the reference value.

The prediction mode determination includes determining a vertical mode to be the prediction mode of the current block when the variance value calculated in the upper side variance value calculation is greater than or equal to the reference value and the variance value calculated in the left side variance value calculation is less than the reference value.

Another embodiment of the present disclosure provides an intra-prediction decoding method including performing a characteristic information calculation for calculating characteristic information of a directionality by selecting at least one of reference pixels adjacent to a current block to decode, performing a comparison for comparing between a predetermined reference value and the characteristic information of the directionality calculated in the characteristic information calculation, performing a prediction mode determination for determining a prediction mode for the current block to be a mode corresponding to the selected reference pixel when a result of comparison performed in the comparison satisfies a predetermined condition, and decoding the current block based on the mode determined in the prediction mode determination.

The characteristic information calculation includes performing an upper side variance value calculation for calculating a variance value with respect to reference pixels located on an upper side of the current block, and performing a left side variance value calculation for calculating a variance value with respect to reference pixels located on a left side of the current block.

The prediction mode determination includes determining a DC mode to be the prediction mode of the current block when the variance value calculated in the upper side variance value calculation and the variance value calculated in the left side variance value calculation are less than the reference value.

The prediction mode determination includes determining a horizontal mode to be the prediction mode of the current block when the variance value calculated in the upper side variance value calculation is less than the reference value and the variance value calculated in the left side variance value calculation is greater than or equal to the reference value.

The prediction mode determination includes determining a vertical mode to be the prediction mode of the current block when the variance value calculated in the upper side variance value calculation is greater than or equal to the reference value and the variance value calculated in the left side variance value calculation is less than the reference value.

### DESCRIPTION OF DRAWINGS

FIG. 1 is a block diagram schematically illustrating general inter-prediction;

FIG. 2 is a diagram illustrating a directionality of an intra-prediction mode.

FIG. 3 is a diagram illustrating an example of a labeling for describing the intra-prediction mode of FIG. 2;

FIG. 4 is a diagram illustrating each intra-prediction mode of FIG. 2;

FIG. 5 is a diagram schematically illustrating an intra-prediction encoding apparatus according to an embodiment of the present disclosure;

FIG. 6 is a flowchart illustrating an intra-prediction encoding method performed by the intra-prediction encoding apparatus of FIG. 5;

FIG. 7 is a diagram schematically illustrating an intra-prediction decoding apparatus according to an embodiment of the present disclosure; and

FIG. 8 is a flowchart illustrating an intra-prediction decoding method performed by the intra-prediction decoding apparatus of FIG. 7.

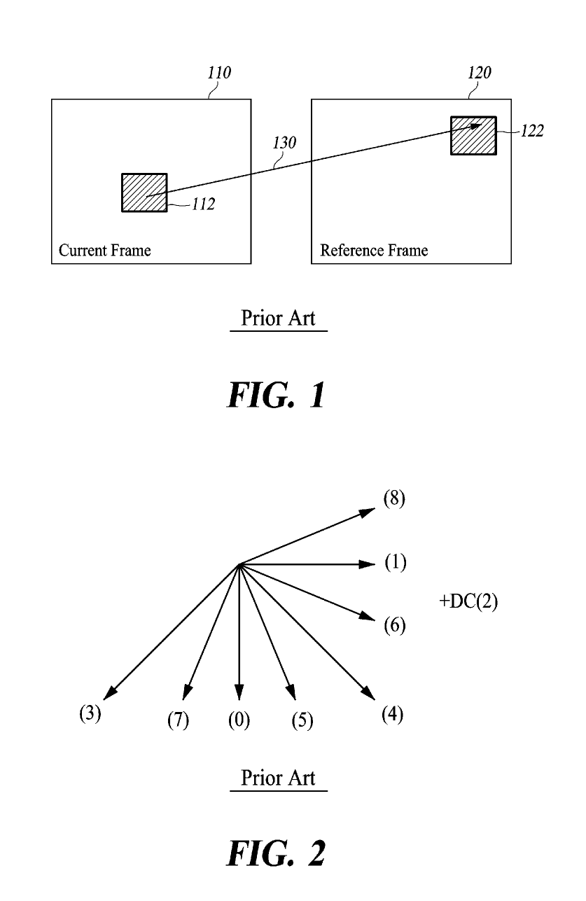

### DETAILED DESCRIPTION

An embodiment of the present disclosure to solve the above-mentioned problem provides an intra-prediction encoding/decoding apparatus and method that omits transmission of additional information associated with a prediction mode of a current block by using characteristics of reference pixels adjacent to a current block and thus, overhead may be reduced from occurring when a bitstream is generated, and efficiency of encoding and decoding an image may be improved while maintaining the accuracy of intra-prediction.

Hereinafter, embodiments of the present disclosure will be described in detail with reference to the accompanying drawings. In the following description, like reference numerals designate like elements although they are shown in different drawings. Further, in the following description of the present embodiments, a detailed description of known functions and configurations incorporated herein will be omitted for the purpose of clarity.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

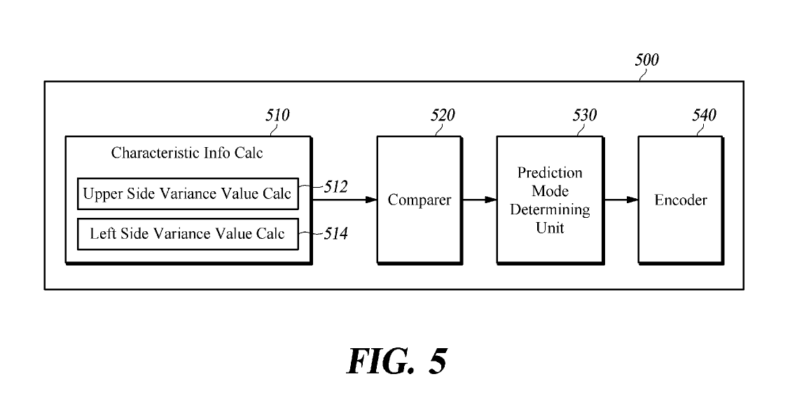

FIG. 5 is a diagram schematically illustrating an intra-prediction encoding apparatus according to an embodiment of the present disclosure. Referring to FIG. 5, an intra-prediction encoding apparatus 500 includes a characteristic information calculator 510, a comparer 520, a prediction mode determining unit 530, and an encoder 540.

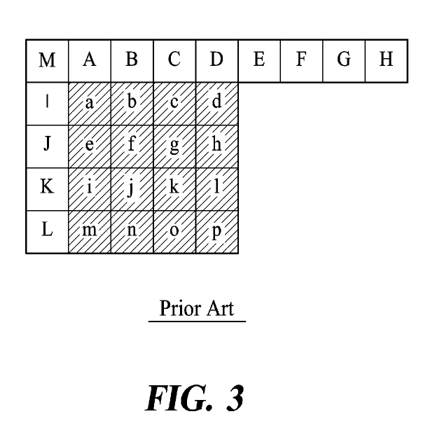

The characteristic information calculator 510 calculates characteristic information of a directionality by selecting at least one of reference pixels adjacent to a current block to encode. Here, the characteristic information calculator 510 includes an upper side variance value calculator 512 to calculate a variance value with respect to reference pixels located on an upper side of the current block and a left side variance value calculator 514 to calculate a variance value with respect to reference pixels located on a left side of the current block. For example, the upper side variance value calculator 512 calculates a variance value as shown in Equation 2, by selecting the A, B, C, and D pixels adjacent to the upper side of the current block in FIG. 3, and the left side variance value calculator 514 calculates a variance value as shown in Equation 3, by selecting the I, J, K, and L pixels adjacent to the left side of the current block.

$$\begin{matrix}{σ}_{T} = {\sum }_{P = [ A , B , C , D ]} {( P - {Mean}_{A , B , C , D} )}^{2} & Equation 2 \\ {σ}_{L} = {\sum }_{P = [ I , J , K , L ]} {( P - {Mean}_{I , J , K , L} )}^{2} & Equation 3\end{matrix}$$

Although it is described that the variance values are calculated by selecting the adjacent pixels located on the upper side and the left side of the current block, a range of reference pixels to be selected for the current block may not be limited thereto.

The comparer 520 compares, to a predetermined reference value, the characteristic information of the directionality calculated by the characteristic information calculator 510. For example, as described in the foregoing, when the characteristic information calculator 510 calculates the variance value of the pixels adjacent to the upper side of the current block and the variance value of the pixels adjacent to the left side of the current block through the upper side variance value calculator 512 and the left side variance value calculator 514, the comparer 520 may compare each of the calculated variance values to the predetermined reference value. In this example, the reference value is a threshold value of the reference pixels for the current block, and may be set to an average of reference pixel values within a predetermined range from the current block or may be set to a value of a predetermined percentage from an upper limit.

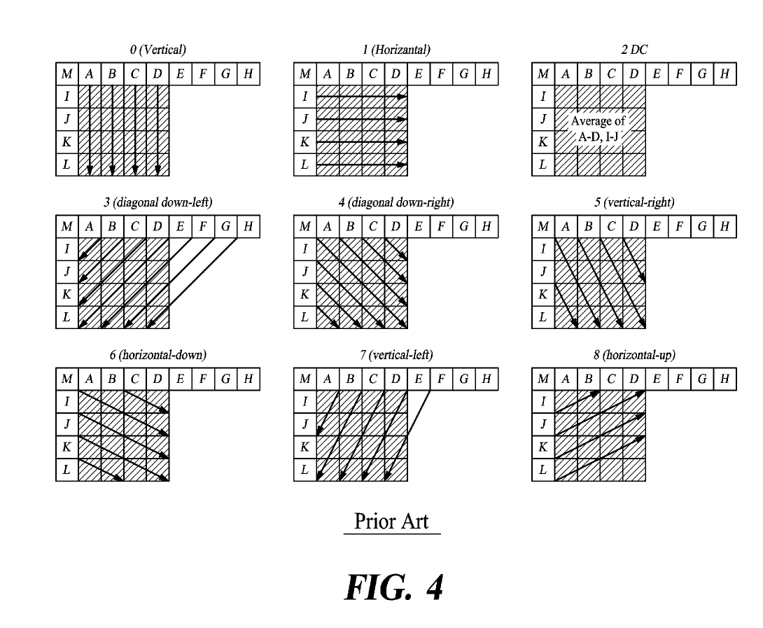

The prediction mode determining unit 530 determines a mode corresponding to the selected reference pixel to be a prediction mode of the current block when a result of comparison performed by the comparer 520 satisfies a predetermined condition. As described in the foregoing, when the characteristic information calculator 510 calculates the variance value of the pixels adjacent to the upper side of the current block and the variance value of the pixels adjacent to the left side of the current block through the upper side variance value calculator 512 and the left side variance value calculator 514, the prediction mode determining unit 530 may determine, to be the prediction mode of the current block, a corresponding mode of each selected reference pixel based on a result of comparison between the each calculated variance value and the reference value. For example, when the variance value calculated by the upper side variance value calculator 512 and the variance value calculated by the left side variance value calculator 514 are less than the reference value, the prediction mode determining unit 530 assumes that a directionality of the current block does not exist and may determine a DC mode (the mode 2 in FIG. 4) to be the prediction mode of the current block. Also, when the variance value calculated by the upper side variance value calculator 512 is less than the reference value and the variance value calculated by the left side variance value calculator 514 is greater than or equal to the reference value, the prediction mode determining unit 530 may determine a horizontal mode (the mode 1 in FIG. 4) to be the prediction mode of the current block. Also, when the variance value calculated by the upper side variance value calculator 512 is greater than or equal to the reference value and the variance value calculated by the left side variance value calculator 514 is less than the reference value, the prediction mode determining unit 530 may determine a vertical mode (the mode 0 in FIG. 4) to be the prediction mode of the current block.

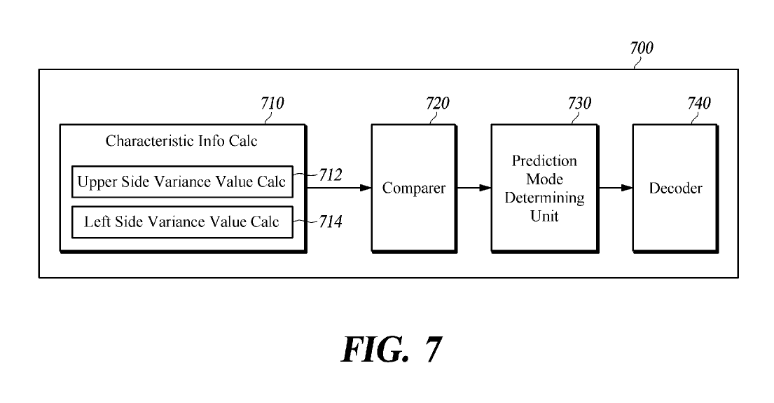

The encoder 540 encodes a residual between the current block and a predicted block of the mode determined by the prediction mode determining unit 530 and transmits the encoded residual to a decoder when the result of comparison performed by the comparer 520 satisfies the predetermined condition. In this example, the decoder may be set to determine a prediction mode of the current block to decode based on the same condition as the intra-prediction encoding apparatus 500. Therefore, the encoder 540 may omit encoding mode information of the mode determined by the prediction mode determining unit 530, which will be described with reference to the descriptions of an intra-prediction decoding apparatus 700 (please refer to FIG. 7).

When the result of comparison performed by the comparer 520 fails to satisfy the predetermined condition, the encoder 540 may estimate a prediction mode that minimizes a cost of encoding based on a general method such as H.264 and may encode a residual between the current block and the prediction mode.

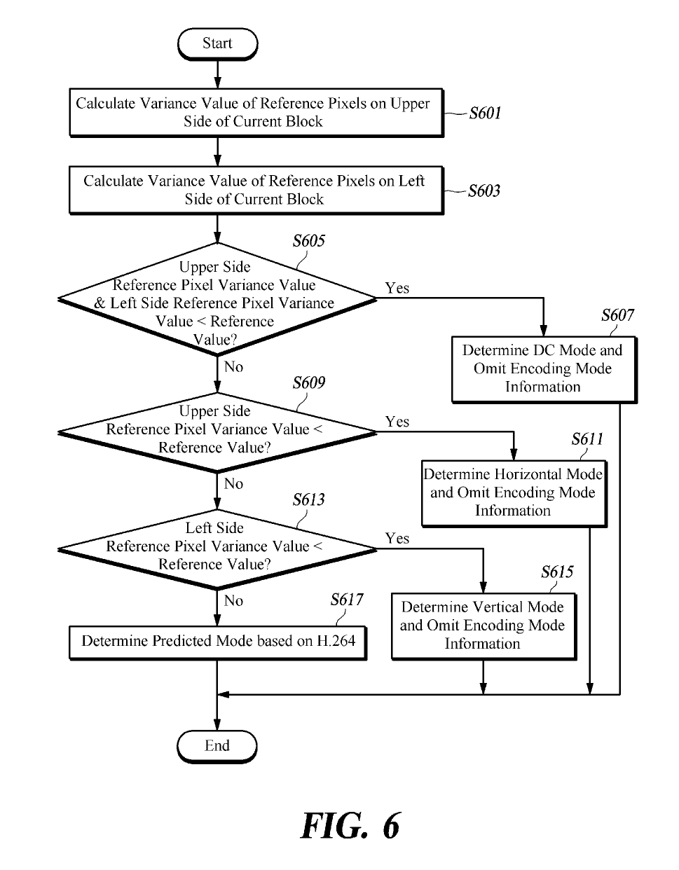

FIG. 6 is a flowchart illustrating an intra-prediction encoding method performed by the intra-prediction encoding apparatus of FIG. 5.

Referring to FIGS. 5 and 6, the characteristic information calculator 510 calculates characteristic information of a directionality by selecting at least one of reference pixels adjacent to a current block to encode. In this example, the characteristic information calculator 510 may calculate a variance value as shown in Equation 2, by selecting pixels A, B, C, and D adjacent to the upper side of the current block of FIG. 3 in step S601. Also, the characteristic information calculator 510 may calculate a variance value as shown in Equation 3, by selecting pixels I, J, K, and L adjacent to the left side of the current block in step S603. When the characteristic information calculator 510 calculates the upper side variance value by selecting pixels adjacent to the upper side of the current block and calculates the left side variance value by selecting pixels adjacent to the left side of the current block, the comparer 520 may compare each of the calculated variance values to a predetermined reference value. In this example, the reference value may be a threshold value of reference pixels for the current block, and may be set to an average of reference pixel values within a predetermined range from the current block or may be set to a value of a predetermined percentage from an upper limit.

The prediction mode determining unit 530 determines a mode corresponding to the selected reference pixel to be a prediction mode of the current block when a result of comparison performed by the comparer 520 satisfies a predetermined condition. For example, when the upper side variance value and the left side variance value are less than the reference value in step S605, the prediction mode determining unit 530 assumes that a directionality of the current block does not exist, and determines a DC mode (the mode 2 in FIG. 4) to be the prediction mode of the current block in step S607. Also, when the variance value calculated by the upper side variance value calculator 512 is less than the reference value and the variance value calculated by the left side variance value calculator 514 is greater than or equal to the reference value in step S609, the prediction mode determining unit 530 determines a horizontal mode (the mode 1 in FIG. 4) to be the prediction mode of the current block in step S611. Also, the variance value calculated by the upper side variance value calculator 512 is greater than or equal to the reference value and the variance value calculated by the left side variance value calculator 514 is less than the reference value in step S613, the prediction mode determining unit 530 determines a vertical mode (the mode 0 in FIG. 4) to be the prediction mode of the current block in step S615. In this example, when the result of comparison performed by the comparer 520 satisfies the predetermined condition, the encoder 540 encodes a residual between the current block and a predicted block of a mode determined by the prediction mode determining unit 530 and transmits the encoded residual to a decoder, and may omit encoding mode information of the mode determined by the prediction mode determining unit 530.

When the result of comparison performed by the comparer 520 fails to satisfy the predetermined condition, the encoder 540 estimates a prediction mode that minimizes a cost of encoding based on a general method such as H.264 and encodes a residual between the current block and the predicted mode in step S617.

FIG. 7 is a diagram schematically illustrating an intra-prediction decoding apparatus according to an embodiment of the present disclosure. Referring to FIG. 7, the intra-prediction decoding apparatus 700 includes a characteristic information calculator 710, a comparer 720, a prediction mode determining unit 730, and a decoder 740.

The characteristic information calculator 710 calculates characteristic information of a directionality by selecting at least one of reference pixels adjacent to a current block to decode. Here, the characteristic information calculator 710 includes an upper side variance value calculator 712 to calculate a variance value with respect to reference pixels located on an upper side of the current block and a left side variance value calculator 714 to calculate a variance value with respect to reference pixels located on a left side of the current block. For example, the upper side variance value calculator 712 calculates a variance value as shown in Equation 2, by selecting pixels A, B, C and D adjacent to the upper side of the current block in FIG. 3, and the left variance value calculator 714 calculates a variance value as shown in Equation 3 by selecting pixels I, J, K and L adjacent to the left side of the current block. Although it is described that the variance values are calculated by selecting the adjacent pixels located on the upper side and the left side of the current block, a range of reference pixels to be selected for the current block may not be limited thereto. However, it is desirable that the characteristic information calculator 710 selects at least one of reference pixels adjacent to the current block based on the same condition as an encoder. For example, when the encoder selects pixels adjacent to an upper side and a left side of a current block to encode, it is desired that the characteristic information calculator 710 of the intra-prediction decoding apparatus 700 according to an embodiment of the present disclosure also selects pixels adjacent to an upper side and a left side of a current block to decode.

The comparer 720 compares between a predetermined reference value, and the characteristic information associated with the directionality calculated by the characteristic information calculator 710. For example, as described in the foregoing, when the characteristic information calculator 710 calculates the variance value of the pixels adjacent to the upper side of the current block and the variance value of the pixel adjacent to the left side of the current block through the upper side variance value calculator 712 and the left side variance value calculator 714, the comparer 720 may compare each of the calculated variance values to the predetermined reference value. In this example, the reference value is a threshold value of reference pixels for the current block, and may be set to an average of reference pixel values within a predetermined range from the current block or may be set to a value of a predetermined percentage from an upper limit.

The prediction mode determining unit 730 determines a mode corresponding to the selected reference pixel to be a prediction mode of the current block when a result of comparison performed by the comparer 720 satisfies a predetermined condition. As described in the foregoing, the characteristic information calculator 710 calculates the variance value of the pixels adjacent to the upper side of the current block and the variance value of the pixels adjacent to the left side of the current block through the upper side variance value calculator 712 and the left side variance value calculator 714, the prediction mode determining unit 730 may determine, to be the prediction mode of the current block, a corresponding mode of each selected reference pixel based on the result of comparison between each of the calculated variance values and the reference value. For example, when the variance value calculated by the upper side variance value calculator 712 and the variance value calculated by the left side variance value calculator 714 are less than the reference value, the prediction mode determining unit 730 assumes that a directionality of the current block does not exist and determines a DC mode (the mode 2 in FIG. 4) to be the prediction mode of the current block. Also, when the variance value calculated by the upper side variance value calculator 712 is less than the reference value and the variance value calculated by the left side variance value calculator 714 is greater than or equal to the reference value, the prediction mode determining unit 730 determines a horizontal mode (the mode 1 in FIG. 4) to be the prediction mode of the current block. Also, when the variance value calculated by the upper side variance value calculator 712 is greater than or equal to the reference value and the variance value calculated by the left side variance value calculator 714 is less than the reference value, the prediction mode determining unit 730 determines a vertical mode (the mode 0 in FIG. 4) to be the prediction mode of the current block.

When the result of comparison performed by the comparer 720 satisfies the predetermined condition, the decoder 740 decodes a residual signal received through a bitstream and adds the decoded residual signal to a predicted block of the mode determined by the prediction mode determining unit 730 so as to reconstruct the current block to decode.

When the result of comparison performed by the comparer 720 fails to satisfy the predetermined condition, the decoder 740 estimates a prediction mode that minimizes a cost of encoding based on a general method such as H.264, and adds the decoded residual signal to the estimated prediction mode so as to reconstruct the current block.

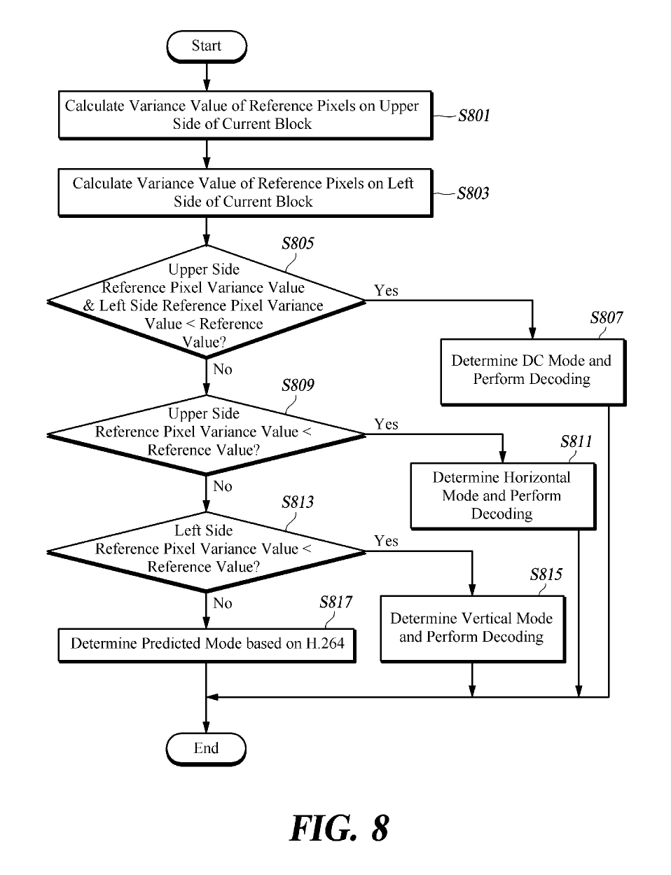

FIG. 8 is a flowchart illustrating an intra-prediction decoding method performed by the intra-prediction decoding apparatus of FIG. 7.

Referring to FIGS. 7 and 8, the characteristic information calculator 710 calculates characteristic information of a directionality by selecting at least one of reference pixels adjacent to a current block to decode. In this example, the characteristic information calculator 710 may calculate a variance value as shown in Equation 2, by selecting pixels A, B, C and D adjacent to the upper side of the current block in FIG. 3 in step S801. Also, the characteristic information calculator 710 calculates a variance value as shown in Equation 3, by selecting pixels I, J, K, and L adjacent to the left side of the current block in step S803. When the characteristic information calculator 710 calculates the upper side variance value by selecting the pixels adjacent to the upper side of the current block and the left side variance value by selecting the pixels adjacent to the left of the current block, the comparer 720 may compare each of the calculated variance values to a predetermined reference value. In this example, the reference value is a threshold value of reference pixels for the current block, and may be set to an average of reference pixel values within a predetermined range from the current block or may be set to a value of a predetermined percentage from an upper limit.

The prediction mode determining unit 730 determines a mode corresponding to the selected reference pixel to be a prediction mode of the current block when a result of comparison performed by the comparer 520 satisfies a predetermined condition. For example, when the upper side variance value and the left side variance value are less than the reference value in step S805, the prediction mode determining unit 730 assumes that a directionality of the current block does not exist and determines a DC mode (the mode 2 in FIG. 4) to be the prediction mode of the current block in step S807. Also, when the variance value calculated by the upper side variance value calculator 712 is less than the reference value and the variance value calculated by the left side variance value calculator 714 is greater than or equal to the reference value in step S809, the prediction mode determining unit 730 determines a horizontal mode (the mode 1 in FIG. 4) to be the prediction mode of the current block in step S811. Also, the variance value calculated by the upper side variance value calculator 712 is greater than or equal to the reference value and the variance value calculated by the left side variance value calculator 714 is less than the reference value in step S813, the prediction mode determining unit 730 determines a vertical mode (the mode 0 in FIG. 4) to be the prediction mode of the current block in step S815. In this example, when the result of comparison performed by the comparer 720 satisfies the predetermined condition, the decoder 740 decodes a residual signal received through a bitstream and adds the decoded residual signal to the predicted block of the mode determined by the prediction mode determining unit 730 so as to reconstruct the current block.

When the result of comparison performed by the comparer 720 fails to satisfy the predetermined condition, the decoder 740 estimates a prediction mode that minimizes a cost of encoding based on a general method such as H.264, and reconstructs the current block in step S817.

According to the present disclosure as described above, transmission of additional information of a prediction mode of a current block may be omitted using characteristics of reference pixels adjacent to a current block and thus, overhead occurring when a bitstream is generated may be reduced, and efficiency in encoding and decoding image may be improved while accuracy with respect to intra-prediction is maintained.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the embodiments of the present disclosure. The computer readable media may include magnetic recording media, optical recording media, and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary embodiments of the present disclosure have been described for illustrative purposes, those skilled in the art will appreciate that various modifications, additions and substitutions are possible, without departing from essential characteristics of the disclosure. Therefore, exemplary embodiments of the present disclosure have not been described for limiting purposes. Accordingly, the scope of the disclosure is not to be limited by the above embodiments but by the claims and the equivalents thereof.

### CROSS-REFERENCE TO RELATED APPLICATION

If applicable, this application claims priority under 35 U.S.C §119(a) of Patent Application No. 10-2010-0087292, filed on Sep. 7, 2010 in Korea, the entire content of which is incorporated herein by reference. In addition, this non-provisional application claims priority in countries, other than the U.S., with the same reason based on the Korean Patent Application, the entire content of which is hereby incorporated by reference.

1. An intra-prediction encoding/decoding the apparatus comprising:
an encoder for calculating a variance value by selecting at least one of reference pixels adjacent to a current block to encode, determining a prediction mode of the current block to be a mode corresponding to the selected reference pixel from a comparison between a calculated variance value and a predetermined reference value, and encoding the current block based on a determined prediction mode; and
a decoder for calculating a variance value by selecting at least one of second reference pixels adjacent to the current block to decode determining a second prediction mode of the current block to decode to be a mode corresponding to a selected second reference pixel from a comparison between a calculated variance for the selected second reference pixel and the predetermined reference value, and decoding the current block based on a determined second prediction mode.

2. An intra-prediction encoding the apparatus comprising:
a characteristic information calculator for calculating characteristic information of a directionality by selecting at least one of reference pixels adjacent to a current block to encode;
a comparer for comparing between a predetermined reference value and the characteristic information of the directionality calculated by the characteristic information calculator;
a prediction mode determining unit for determining a prediction mode for the current block to be a mode corresponding to the selected reference pixel when a result of the comparison performed by the comparer satisfies a predetermined condition; and
an encoder for encoding a residual between a predicted block of the determined mode and the current block, and omitting encoding mode information according to the determined mode when the result of the comparison satisfies the predetermined condition.

3. The apparatus of claim 2, wherein the characteristic information calculator comprises:
an upper side variance value calculator for calculating a variance value with respect to reference pixels located on an upper side of the current block; and
a left side variance value calculator for calculating a variance value with respect to reference pixels located on a left side of the current block.

4. The apparatus of claim 3, wherein the prediction mode determining unit determines a DC mode to be the prediction mode of the current block when the variance value calculated by the upper side variance value calculator and the variance value calculated by the left side variance value calculator are less than the reference value.

5. The apparatus of claim 3, wherein the prediction mode determining unit determines a horizontal mode to be the prediction mode of the current block when the variance value calculated by the upper side variance value calculator is less than the reference value and the variance value calculated by the left side variance value calculator is greater than or equal to the reference value.

6. The apparatus of claim 3, wherein the prediction mode determining unit determines a vertical mode to be the prediction mode of the current block when the variance value calculated by the upper side variance value calculator is greater than or equal to the reference value and the variance value calculated by the left side variance value calculator is less than the reference value.

7. An intra-prediction decoding the apparatus comprising:
a characteristic information calculator for calculating characteristic information of a directionality by selecting at least one of reference pixels adjacent to a current block to decode;
a comparer for comparing between a predetermined reference value and the characteristic information of the directionality calculated by the characteristic information calculator;
a prediction mode determining unit for determining a prediction mode for the current block to be a mode corresponding to the selected reference pixel when a result of comparison performed by the comparer satisfies a predetermined condition; and
a decoder for decoding the current block based on the mode determined by the prediction mode determining unit when the result of the comparison satisfies the predetermined condition.

8. The apparatus of claim 7, wherein the characteristic information calculator comprises:
an upper side variance value calculator for calculating a variance value with respect to reference pixels located on an upper side of the current block; and
a left variance value for calculating a variance value with respect to reference pixels located on a left side of the current block.

9. The apparatus of claim 8, wherein the prediction mode determining unit determines a DC mode to be the prediction mode of the current block when the variance value calculated by the upper side variance value calculator and the variance value calculated by the left side variance value calculator are less than the reference value.

10. The apparatus of claim 8, wherein the prediction mode determining unit determines a horizontal mode to be the prediction mode of the current block when the variance value calculated by the upper side variance value calculator is less than the reference value and the variance value calculated by the left side variance value calculator is greater than or equal to the reference value.

11. The apparatus of claim 8, wherein the prediction mode determining unit determines a vertical mode to be the prediction mode of the current block when the variance value calculated by the upper side variance value calculator is greater than or equal to the reference value and the variance value calculated by the left side variance value calculator is less than the reference value.

12. An intra-prediction encoding/decoding method comprising:
performing an encoding for calculating a variance value by selecting at least one of reference pixels adjacent to a current block to encode determining a prediction mode of the current block to be a mode corresponding to the selected reference pixel from a comparison between a calculated variance value and a predetermined reference value, and encoding a current block based on a determined prediction mode; and
performing a decoding for calculating a variance value by selecting at least one of second reference pixels adjacent to the current block to decode, determining a second prediction mode of the current block to be a mode corresponding to a selected second reference pixel from a comparison between a calculated variance for the selected second reference pixel and the predetermined reference value, and decoding the current block based on a determined second prediction mode.

13. An intra-prediction encoding method comprising:
performing a characteristic information calculation for calculating characteristic information of a directionality by selecting at least one of reference pixels adjacent to a current block to encode;
performing a comparison for comparing between a predetermined reference value and the characteristic information of the directionality calculated by the characteristic information calculator;
performing a prediction mode determination to determine a prediction mode for the current block to be a mode corresponding to a selected reference pixel when a result of the comparison satisfies a predetermined condition; and
encoding a residual between a predicted block of the determined mode and the current block and omitting encoding mode information of the determined mode when the result of the comparison satisfies the predetermined condition.

14. The method of claim 13, wherein the characteristic information calculation comprises:
performing an upper side variance calculation for calculating a variance value with respect to reference pixels located on an upper side of the current block; and
performing a left side variance calculation for calculating a variance value with respect to reference pixels located on a left side of the current block.

15. The method of claim 14, wherein the prediction mode determination comprises:
determining a DC mode to be the prediction mode of the current block when the variance value calculated in the upper side variance value calculation and the variance value calculated in the left side variance value calculation are less than the reference value.

16. The method of claim 14, wherein the prediction mode determination comprises:
determining a horizontal mode to be the prediction mode of the current block when the variance value calculated in the upper side variance value calculation is less than the reference value and the variance value calculated in the left side variance value calculation is greater than or equal to the reference value.

17. The method of claim 14, wherein the prediction mode determination comprises:
determining a vertical mode to be the prediction mode of the current block when the variance value calculated in the upper side variance value calculation is greater than or equal to the reference value and the variance value calculated in the left side variance value calculation is less than the reference value.

18. An intra-prediction decoding method comprising:
performing a characteristic information calculation for calculating characteristic information of a directionality by selecting at least one of reference pixels adjacent to a current block to decode;
performing a comparison for comparing between a predetermined reference value and the characteristic information of the directionality calculated in the characteristic information calculation;
performing a prediction mode determination for determining a prediction mode for the current block to be a mode corresponding to a selected reference pixel when a result of comparison performed in the comparison satisfies a predetermined condition; and
decoding the current block based on the mode determined in the prediction mode determination.

19. The method of claim 18, wherein the characteristic information calculation comprises:
performing an upper side variance value calculation for calculating a variance value with respect to reference pixels located on an upper side of the current block; and
performing a left side variance value calculation for calculating a variance value with respect to reference pixels located on a left side of the current block.

20. The method of claim 19, wherein the prediction mode determination comprises:
determining a DC mode to be the prediction mode of the current block when the variance value calculated in the upper side variance value calculation and the variance value calculated in the left side variance value calculation are less than the reference value.

21. The method of claim 19, wherein the prediction mode determination comprises:
determining a horizontal mode to be the prediction mode of the current block when the variance value calculated in the upper side variance value calculation is less than the reference value and the variance value calculated in the left side variance value calculation is greater than or equal to the reference value.

22. The method of claim 19, wherein the prediction mode determination comprises:
determining a vertical mode to be the prediction mode of the current block when the variance value calculated in the upper side variance value calculation is greater than or equal to the reference value and the variance value calculated in the left side variance value calculation is less than the reference value.
